(19) United States
(12) Patent Application Publication
(10) Pub. No.: US 2007/0124235 A1
(43) Pub. Date: May 31, 2007

(54) Method and system for income estimation

(76) Inventors: Anindya Chakraborty, Irving, TX (US); Karen H. Hui, Irving, TX (US); Frederick R. Bader, Colleyville, TX (US)

Correspondence Address: KILPATRICK STOCKTON LLP, 607 14TH STREET, N.W., WASHINGTON, DC, 20005, US

(21) Appl. No.: 11/288,073

(22) Filed: Nov. 29, 2005

(51) Int. Cl. G06Q 40/00

(52) U.S. Cl. 705/38

(57) ABSTRACT

An automated method and system estimates income of an individual loan applicant using credit bureau information and loan attributes. The method and system can use the credit bureau and loan information to calibrate an applicant's debt-burden in cases where such information is not readily available or is unverifiable. The method and system can automatically verify income for applicants who choose to state their income in lieu of providing adequate documentation. Further, the method and system can be applicable to any retail lending business including, but not limited to, mortgage, auto loan, and credit cards, where credit bureau information forms a part of the data collection process and is available along with applicant's information.

### BACKGROUND OF THE INVENTION

1. Field of the Invention

This invention relates generally to the field of income estimation for lending purposes.

2. Description of the Prior Art

In a conventional retail lending business, such as those involving mortgages, lender “documentation requirements” typically stipulate how the applicant must provide information about income and how the lender intends on using the information. Generally, full documentation remains the standard, where the applicant discloses income to the lender, the lender verifies the income, and then the lender uses the verified income in determining the applicant's ability to repay the loan. Formal verification, if required, typically includes the steps of the borrower's employer verifying employment and/or the borrower's bank verifying deposits. In order to save time, alternative documentation, such as copies of the borrower's original bank statements, W-2s, and paycheck stubs, may be used as surrogates.

There are numerous conventional documentation programs in the mortgage lending business. Because many applicants are sometimes shut out of the market by excessively rigid documentation requirements, lenders realize the need for additional documentation programs, especially for those applicants who are self-employed or cannot easily document their income. In these situations, a stated income loan program is more commonplace, especially when the applicants disclose their income without verification.

Stated income loans may be perceived to be riskier than full documentation loans. Without an adequate verification process, the lender risks that some applicants may overstate their income in order to achieve lower debt-to-income ratio, a key determinant of payment ability in the underwriting process, in order to obtain approval for a particular loan. As a result, applicants stating their income may compromise with higher rates, larger down payments, higher credit score requirements, or a combination thereof. From the lender's perspective, such tradeoffs may not justify the balance between risk and reward for stated income loans. From the applicants' perspective, higher rates and larger down payments are not desirable for those who honestly stated their actual income and opted for the stated income program in order to simplify the loan processing procedure or to maintain their privacy.

Conventional income estimation systems are used in the fields of economics and social science, as well as by the U.S. government. However, these systems typically do not estimate an individual's income and do not use past credit and risk performance obtained from credit bureau attributes or an applicant's loan information. Various agencies of the U.S. government have developed different methodologies for estimating median income for the purpose of an area income census, housing affordability, or regional poverty levels. In one conventional system, the median household income for a small region was estimated as a function of various variables taken from administrative records. Although this method directly relates to income estimation, it does not translate to income estimation for an individual. In another non-analogous conventional system, an income estimation method correlates education levels with household income, which is not applicable in retail loan processing. Therefore, it is desirable to have a method and a system that estimates an applicant's income for a retail lending program by using credit bureau and loan attributes.

### SUMMARY OF THE INVENTION

An automated method and system for estimating income of an individual loan applicant uses credit bureau information and loan attributes. The method and system can use the credit bureau and loan information to calibrate an applicant's debt-burden in cases where such information is not readily available or is unverifiable. The method and system can automatically verify income for applicants who choose to state their income in lieu of providing adequate documentation. Further, the method and system can be applicable to any retail lending business including, but not limited to, mortgage, auto loan, and credit cards, where credit bureau information forms a part of the data collection process and is available along with applicant's information.

It is desirable that the method and system extract the relevant information from credit bureau and loan information to estimate an applicant's true income. Further, it is desirable to provide lenders with an option to extend an applicant the benefit of advantageous pricing in a stated income loan program based on a comparison between the applicant's stated income and the estimated income.

The method and system described herein use techniques to select most predictive variables from a large pool of candidates, clean up the potential outliers/errors among a data set, and extracts the relevant information from the candidate predictors to build a final model to estimate the applicant's income. The parameters of a multivariate adaptive regression splines (“MARS”) based prediction system are estimated from a database consisting of borrower information on full-documentation loan consumers, where the actual income are known and have been verified. Development/hold-out/out-of-time validations along with bootstrap re-sampling techniques provide a model that attempts to minimize the error between actual income and predicted income. Furthermore, a cautious and systematic comparison is performed between stated debt ratio, i.e., debt-burden calculated from the applicant's stated income, and predicted debt ratio, i.e., debt-burden calculated from the estimated income.

Additional features and advantages of the invention will be set forth in the description which follows, and in part will be apparent from the description, or may be learned by practice of the invention. The objectives and other advantages. of the invention will be realized and attained by the structure particularly pointed out in the written description and claims hereof as well as the appended drawings.

It is to be understood that both the foregoing general description and the following detailed description are exemplary and are intended to provide further explanation of the invention as claimed.

### BRIEF DESCRIPTION OF THE DRAWINGS

The present invention will be more clearly understood from a reading of the following description in conjunction with the accompanying exemplary figures wherein:

FIG. 1 shows a flowchart of the method according to an exemplary embodiment of the present invention;

FIGS. 2a and 2b show histograms of average months on file according to an exemplary embodiment of the present invention;

FIG. 3 shows outlier detection according to an exemplary embodiment of the present invention;

FIGS. 4a and 4b show outlier detection according to an exemplary embodiment of the present invention;

FIG. 5 shows a bootstrapping chart according to an exemplary embodiment of the present invention;

FIG. 6 shows a matrix of performance measures according to an exemplary embodiment of the present invention;

FIG. 7 shows a confidence matrix according to an exemplary embodiment of the present invention; and

FIG. 8 shows a table of performance according to an exemplary embodiment of the present invention.

### DETAILED DESCRIPTION

It will be recognized that the principles disclosed herein may extend beyond the realm of mortgages and that it may be applied to any lending process or other process requiring an estimation of income.

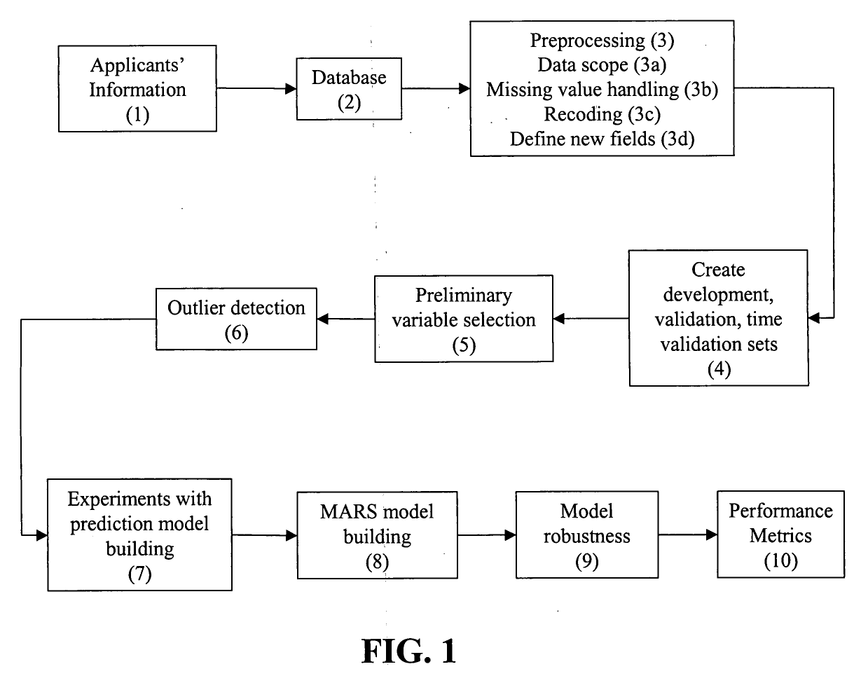

Referring to FIG. 1, a flowchart of the method according to an exemplary embodiment of the present invention is shown. In step 1, applicant information is collected. The system collects information, such as credit bureau attributes and loan information, into a record. Preferably, the information is collected in or converted to a digital format.

In step 2, a database is formed. A valid case has full documentation applicants with verified income. These applicants' income values are used as a target dependent variable. Records corresponding to each valid case are stored in a database to be used for model construction, testing, and validation.

Implementation of this system on a computer preferably utilizes a database, which can be hosted on a server that stores information on the borrowers in a digital format. Further, in order to replicate the model building steps involved in the methodology described below, the system preferably has a workstation having an installation (e.g., server/client or desktop) of any commonly available licensed commercial analytical/statistical software capable of running the techniques described herein or similar software or technique known to one of ordinary skill in the art.

More specifically, in steps 1 and 2, the system establishes a database of prior full-documentation applications along with corresponding loan and credit bureau attributes. The purpose of the full-documentation application is to build a valid model with a development sample having trusted and verified income as the target or dependent variable. This database also includes the applicants' loan application, as well as credit bureau attributes, which could be purchased from any or all of the three national credit bureaus: TransUnion, Equifax, or Experian. Accordingly, this database forms the basis of the system for income estimation development and validation. Preferably, the characteristics of the certified full documentation applications database closely resemble those of incoming stated income loan applications received within a reasonable time window, i.e., form a “representative sample.”

In step 3, the records are preprocessed to facilitate model construction by preliminary data cleansing and rearranging, which mainly focuses on defining a valid data scope and creating new predictive variables. The preprocessing step comprises four steps: (3a) defining valid data scope, i.e., focusing on the valid range for each field; (3b) missing values handling; (3c) recoding, i.e., generating valid values for each field; and (3d) variable transformation, i.e., defining new effective variables for model building.

The system analyzes the data and its various characteristics in order to appropriately pre-process the data for extracting the maximum signal out of the available data. The system recognizes credit bureau attributes—all existing bureau coding rules that are used to replace the missing values or to represent ordinal categories—for examination and recoding in order to recreate valid values that can be used for model development.

During this preprocessing step, the system defines a valid prediction scope for each variable and develops appropriate strategies for dealing with missing data fields. Additionally, the data is transformed or recreated to produce more effective variables under consideration. Examples would be—either converting one type of data to another, such as converting categorical values to numeric ones, or deriving new promising variables. We discuss these sub-steps in detail further.

In step 3a, a valid data scope is defined. Within different business scenarios, scopes for both dependent variables (e.g., income) and independent variables can be examined and the “normal acceptable range” can be extracted in accordance with the existing acceptable business criteria. For example, in the mortgage business, a loan-to-value (“LTV”) is an expression of the loan amount as a percentage of the total appraised value of a piece of real estate. Typically, the usual valid value of LTV ranges between 25 to 125%. Similarly, Debt ratios typically do not exceed 75%. Accordingly, all values beyond these ranges should be either truncated or discarded.

In step 3b, the system handles missing values. Because historical applicants' credit bureau attributes and loan information are used for income estimator development, missing values are almost unavoidable due to various underwriting system practices and/or data entry reasons. Various methodologies in literature can be applied to deal with missing values, such as single value substitution (mean/median/mode), class mean substitution, regression substitution, or other missing value replacement tools known to one of ordinary skill in the art. In this exemplary embodiment, the accounts with missing credit bureau attributes (i.e., no hits) are excluded from the development process, especially with adequate data in the available sample and instances of occurrence of such missing attributes are substantially negligible.

In the data cleansing process of step 3c, the system considers special coding rules for credit bureau attributes. For example, if an account has never had a record for certain numeric attributes, such as the common variable of number of open trades, the original bureau coding gives a value of “999” to this account. The value of “999” is not a valid number for model development. Accordingly, the system replaces the “999” coding with a “0.”

In the variable transformation step 3d, new variables that can better predict income are generated from credit bureau attributes including, but not limited to, credit utilization, mortgage utilization, and months since bankruptcy.
Credit Utilization %=(Total Credit Balance)/(Total Credit Limit)*100
Mortgage Utilization %=(Mortgage Balance)/(Mortgage Limit)*100
Months Since Bankruptcy=Interval (Bankruptcy Date, Application Date)

In step 4, the system creates development, validation, and time validation sets. The system defines a time point beyond which all of the cases are used to form an out-of-time validation sample. Within the determined time point, all of the cases are split into a x % group, which is typically greater than 50%, e.g., 60%, for uses as a development sample and a 100-x % group for use as a hold-out validation sample.

In step 5, a preliminary variable selection is performed. Important variables are selected out of a large pool of candidate variables obtained from the credit attributes and mortgage loan information. The system adopts techniques to choose a set of explanatory variables that have the maximum prediction power for creating the income estimator. Possible candidate predictors are created by combining credit bureau attributes, loan information, and newly created variables. In this exemplary embodiment, there are more than 150 possible candidate predictors.

Various automatic variable selection methods can be applied to this income estimation process, such as stepwise selection under multivariate regression, partial least squares (“PLS”) regression with the variable importance in the projection (“VIP”) scores and estimated coefficients, genetic search driven by genetic algorithms (“GA”), classification and regression tree (“CART”), and Treenet, as well as any other variable selection methods known to one of ordinary skill in the art. Stepwise selection is commonly used due to its simplicity. However, when using stepwise selection, chosen predictors that look satisfactory in a sample can generalize poorly for “thru-the-door” data applied in practice.

In this exemplary embodiment, prediction accuracy is comparatively more important than exploratory analysis of the relationship between income and other predictive variables. Treenet can be used in conjunction with CART as the main methodology to pre-select the most predictive variables, which are then used as the input variables for next-step MARS modeling. In addition, PLS Regression with the VIP Scores and Estimated Coefficients can also be used as a variable pre-selection method for building a competing Global Linear Regression, used in the experiments of prediction model building discussed below.

Treenet is a gradient tree-boosting technique, which can select important variables out of complex data structures based on their relative prediction influence by using a slow learning process. Additionally, Treenet automates missing values handling and predictor selection, is substantially impervious to outliers, and self-tests to prevent over-fitting. Over-fitting occurs when the number of factors gets too large and the resulting model fits the sampled data, but fails to predict new data well. A Treenet model typically consists of hundreds of small additive regression trees, each of which contributes to the overall model. Its learning process can be a long series expansion, i.e., a sum of factors that becomes progressively more accurate as the expansion continues. The expansion can be written as:
F(X)=F₀+β₁T₁(X)+β₂T₂(X)+. . . +β_{M}T_{M}(X)
where F(X) represents the final Treenet model built from the underlying set of variables denoted by X and each Tᵢ(X) is a small tree with a limited number (e.g., restricted to 4-6) of leaf or terminal nodes and utilizes a suitable combination/subset of variables from the set X. F₀ represents the overall mean (i.e., average) value of the target variable and βᵢ represent the corresponding additive weights (i.e., coefficients) of each tree as it related to the final Treenet model.

By averaging the relative influences of each variable Jⱼ over the sum of the small trees, the final ranking of the variable importance is:

$$\begin{matrix}{\hat{J}}_{j}^{2} ( T ) = {\sum }_{t = 1}^{L - 1} {\hat{I}}_{t}^{2} 1 ( {v}_{t} = j ) & ( 1 ) \\ {\hat{J}}_{j}^{2} = \frac{1}{M} {\sum }_{m = 1}^{M} {\hat{J}}_{j}^{2} ( {T}_{m} ) & ( 2 )\end{matrix}$$

In equation (1), the summation is over the non-terminal nodes t of the L -terminal node tree T, vₜ is the splitting variable associated with node t, and Îₜ² is the corresponding empirical improvement in squared error as a result of the split. Equation (2) is the average value of Jⱼ over a collection of decision trees {Tₘ}₁^{M}. The influence of the estimated most influential variable j* is arbitrarily assigned the value J_{j*=}100, and the estimated values of the others can be scaled accordingly. Top influential variables with relatively large influence values are selected as the candidate input variables for the next step of MARS model building.

In PLS regression with the VIP scores and estimated coefficients, the regression coefficients represent the importance each predictor has in the prediction of the response and the VIP represents the value of each predictor in fitting the PLS model for both predictors and response. The variables, which have relatively larger coefficients (absolute value) and a large VIP score, are chosen as the pre-selected variables to build the Global Linear Regression model.

In step 6, the system detects potential outliers and strange data values caused by possible typographical and uploading errors. Various methodologies in linear regression can be applied to this income estimation process to detect over-influential cases. Such methodologies include, but are not limited to, Euclidean distance in PLS model, studentized deleted residuals for detecting outlying dependent variable cases, hat matrix leverage values for detecting outlying independent variable cases, DFFITS, Cook's distance, and difference in betas (“DFBETAS”) for detecting influential cases in a linear regression model context, as well as other outlier detection tools, such as Random Forest.

In this exemplary embodiment, a tail-capping rule can be applied to all Treenet-selected continuous variables. Additionally, Random Forest is used to detect potential outliers. Euclidean distance in PLS model is used to detect outliers for the Global Linear Regression model.

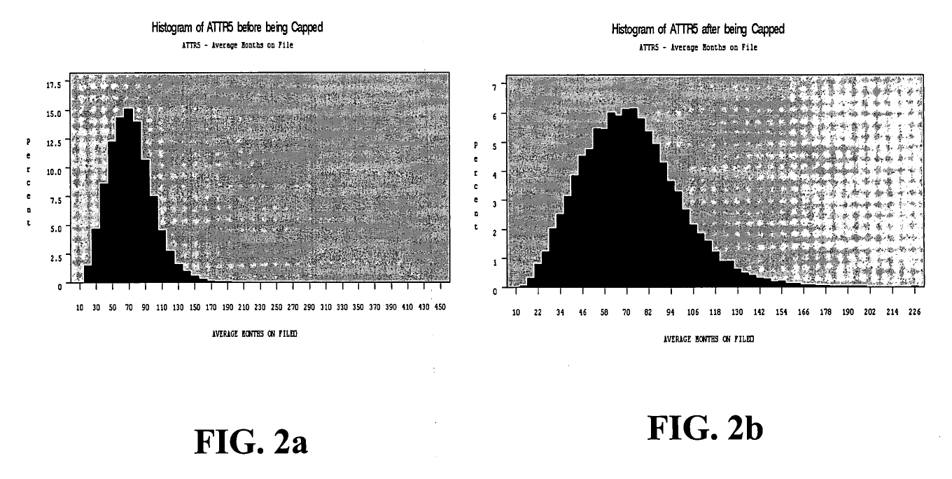

To avoid seriously skewed distribution, extreme cases can be capped, e.g., capped at the 99 percentile value for all-important continuous variables. Thus, in this example, the 99^{th} percentile value of a continuous distribution leaves out the top 1 percent extreme values for the distribution. Referring to the histograms in FIGS. 2a and 2b, the distribution of average months on file before or after being capped is shown.

The Random Forest classifier uses a large number of individual decision trees and decides the class by choosing the mode, i.e., most frequently occurring, of the classes as determined by the individual trees. Random Forest generates and combines decision trees into predictive models and display data patterns with a high degree of accuracy. Random Forest is a collection of CART trees that are not influenced by each other when constructed. The sum of the predictions made from decision trees determines the overall prediction of the forest. Two forms of randomization occur in Random Forests: (1) by trees and (2) by node. At the tree level, randomization takes place via observations. At the node level, randomization takes place by using a randomly selected subset of predictors. Each tree is grown to a maximal size and left unpruned, i.e., the tree is not scaled back into a simpler tree. The process is repeated until a user-defined number of trees is created. Once the forest of trees is created, the predictions for each tree are used in a “voting” process. The overall prediction is determined by voting for classification and by averaging for regression.

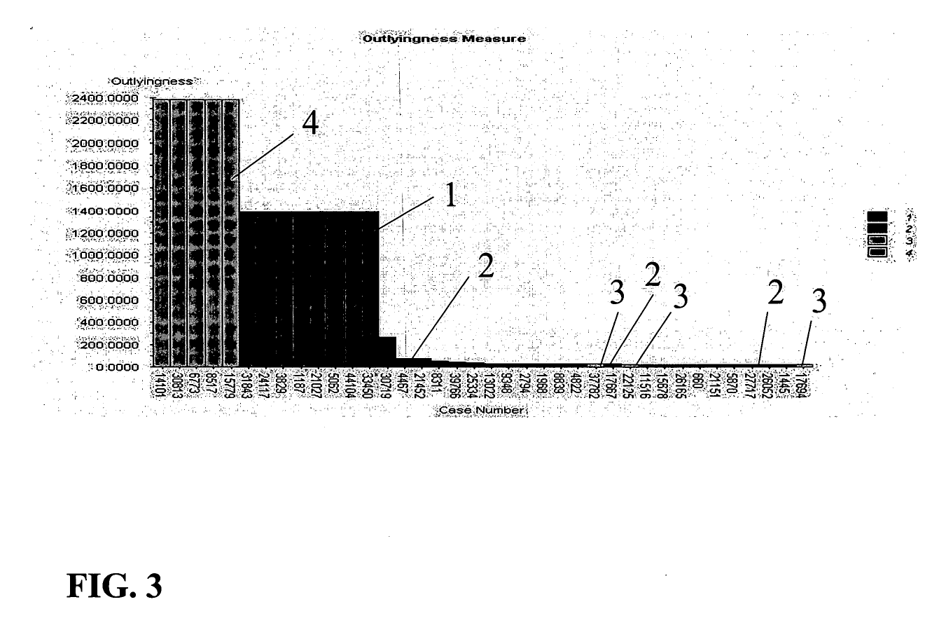

In Random Forest, outliers are cases in which the proximity, as measured by an appropriately defined underlying distance metric, to all other cases in the data set exceeds an acceptance value or threshold. Referring to FIG. 3, to apply Random Forest to the income estimation process, the system groups the monthly income value into a plurality of classes, e.g., four classes, according to equal percentile distribution, and outliers for each of the classes are found separately.

In this embodiment, classes 1 to 4 represent four income groups in an ascending order. The cases that have large outlyingness are deleted from the development data set.

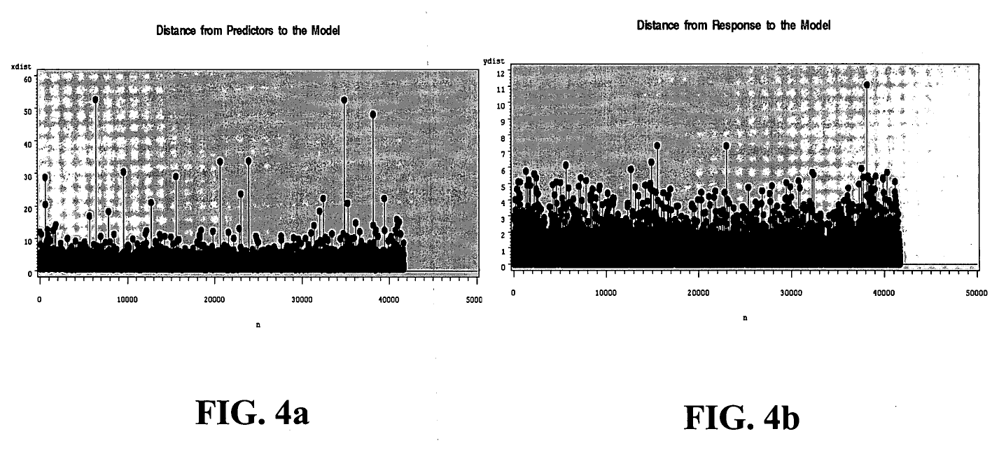

The Euclidean distance from each case to the PLS model in both the standardized predictors and the standardized responses is used to check outliers for building the global linear multivariate regression model. Cases that are dramatically farther from the rest of the population are excluded from the model development sample as shown in the following FIGS. 4a and 4b.

In step 7, the system experiments with varied modeling techniques such as global linear multivariate regression, regression tree and Treenet and MARS to create viable models. In this exemplary embodiment, MARS is selected as the final modeling paradigm. Because an applicant's monthly income is a continuous response variable, a variety of continuous response estimation or transfer function approximation techniques can be applied including, but not limited to, linear regression, regression tree, Treenet/MART and MARS. Predictive regression models can be built by using each of these regression-forecasting techniques.

A global multivariate linear regression model, which is essentially a main-effects fit, can be built by using PLS regression with the VIP scores and estimated coefficients to pre-select input variables. By running another stepwise selection, insignificant variables can be further pruned in the model. The global multivariate linear regression model provides a moderate fit to the income estimation problem. The global multivariate linear regression model does not find appropriate variable transformations and interactions between variables, which can be a time-consuming, yet important step for building traditional multivariate linear regression models. There are other instances where the global multivariate linear regression model is preferable due to its simplicity and common appeal.

A regression tree based model can be built on the data, e.g., using CART. Some other popular decision tree methods include, but are not limited to, chi-squared automatic interaction detector (“CHAID”), C5.0, as well as quick, unbiased, efficient statistical trees (“QUEST”). However, not all of these methods can handle regression class problems directly. As a result, usage of other algorithms can require some variation and adaptability on the practitioner's part. Regression tree is an interaction-based based non-parametric estimation method suitable to handle a continuous prediction problem. To prevent over-fitting of the model, the smallest optimal tree, which is the smallest tree within one standard error of the minimum cost tree, is preferable. In this exemplary embodiment, a regression tree has about 28 terminal nodes. A better accuracy performance can result from choosing a larger tree, but can also lead to an over-fitting problem. Without incorporating any main effects, regression tree has a non-desirable feature that it can only predict 28 discrete values for income for each of the terminal nodes.

Treenet/Multiple Additive Regression Trees (“MART”), which is a gradient tree-boosting technique, can also predict applicants' income. In this embodiment, a sequence of MART models can be built by varying collections of number of trees from 100 to 500, with each having 6-8 terminal nodes. A fraction of the cases, e.g., 20%, can be set aside for validation testing. A Huber-M loss function can be adopted as the regression loss criterion, since it sums either squared deviation or absolute deviation for each observation depending on the relative magnitude of the deviation, and can perform in the presence of outliers. Although Treenet has a much better performance as compared with the other methods, it has a huge tree structure, which although explicitly defined, may not be as easily comprehensible.

In comparison to the other methods identified herein, the global multivariate linear regression model has moderate prediction power without adding any transformations and interactions into the model. Compared with global multivariate linear regression model, the regression tree can automatically find interactions but cannot provide continuously predicted values for the dependent variable. The regression tree also lacks the inclusion of main effects and is interaction heavy, which can result in complex rule sets. Treenet/MART, although preferable to each method in performance, is extremely complex due to the large amounts of small trees. MARS allows both main and interaction effects to be automatically incorporated into the model, being a piecewise-linear adaptive regression procedure that can effectively approximate complex non-linear structures, if present. Additionally, due to the nature of MARS models, which fits into a variety of software capable of running or scoring multivariate regressions, the MARS models are easily portable across software platforms and computer systems. In this exemplary embodiment, MARS produced favorable results as compared to MART and negligible performance degradation when compared across the performance metrics defined in Step 10, below. In view of these comparisons, MARS is preferable as a modeling paradigm for this income estimation process.

In step 8, a MARS model is built. The multivariate adaptive regression splines (“MARS”) model building technique is developed to extract the best information from pre-selected prediction variables and to estimate the applicant's income in the final model. MARS is a piecewise-linear adaptive regression procedure. MARS is essentially a recursive-partitioning procedure, i.e., the partitioning process can be applied over and over again.

The partitioning is done at points of the various explanatory variables defined as “knots” and overall optimization is achieved by performing knot optimization. Moreover, to achieve continuity across partitions, MARS employs a 2-sided power basis function of the form:
b_{q}^{±}(x−t)=[±(x−t)]₊^{q}
When using linear piecewise basis functions, q=1. The variable “t” is the knot around which the basis is formed.

It is preferable to use an optimal number of basis functions to guard against possible overfit. By starting from a small number of maximal basis functions and building it up to a medium size number, the cost-complexity notion can be used to prune back and find a balance in terms of optimality, which can provide an adequate fit. In this exemplary embodiment, about 25-30 basis functions coupled with cost-complexity pruning is sufficient.

Another important criteria which affects the pruning is the estimated degrees of freedom allowed. This can be done by using 10-fold cross validation from the data set for each model.

There is no explicit way by which MARS can handle multi-collinearity. However, since Treenet can be leveraged as the main methodology to make the preliminary selection of input variables for MARS, multi-collinearity problem can be indirectly addressed from the variable selection process, based on the fact that Treenet can help to pick out the most predictive variable amongst several highly correlated variables.

MARS also provides a penalty on added variables, which is a fractional penalty for increasing the distinct number of raw variables used (not basis functions) in the model. Using this parameter, the system can penalize the choice of multi-correlated variables in a downstream partition if a correlated brethren has been chosen earlier in the model building process. Accordingly, MARS works with the original parent, instead of choosing other alternates. In this exemplary embodiment, a medium penalty is used.

In view of the regression model produced by MARS and the inherent cross-sectional nature of the dependent variable, i.e., income, the target dependent variable in its raw form does not follow a normal distribution, which can violate one of the basic assumptions of multivariate linear regression—that the errors from the regression would be homoscedastic, i.e., equal variance, and random normal. A sequence of random variables is homescedastic if all random variables in the sequence have the same finite variance. Heteroscedasticity is a distinct possible issue in the income estimation process. Heteroscedasticity is when a sequence of random variables have different variances. One consequence of heteroscedasticity is that the estimate variance is overestimates or underestimates the true variance. One efficient way to deal with heteroscedasticity is to find an appropriate transformation for the dependent variable, so that in the back-end the distribution of errors become random and homoscedastic in nature. In this exemplary embodiment, additivity and variance stabilization (“AVAS”), which is a nonparametric response transformation procedure, is implemented in a variety of statistical software, e.g., S-Plus, to find the best transformation of the dependent variable. However, AVAS does not produce the analytical form of the transformation, but provides back the transformed variable itself as an output. Nevertheless, one of ordinary skill in the art can experiment with known analytical forms that match the produced transformed shape and can closely approximate the optimal form to address the heteroscedasticity.

An optimal result from AVAS substantially resembles a few variants of the log transformation. In this exemplary embodiment, a variant of the common logistic transformation is applied to a dependent variable (“DV”), with a cap, using a pseudo value Max_{DV}, which should be at least larger, e.g., 10%, than the maximum observed DV value as experienced in the data set:

$${Trans}_{DV} = Log ( \frac{DV}{{Max}_{DV} - DV} )$$

This can limit the effective prediction range of the model to the choice of Max_{DV}. The simple pure-logarithmic transformation overcomes that, but is not as efficient in solving the heteroscedasticity problem. Even after a transformation of the dependent variable has been applied, if heteroscedasticity still exists, an appropriate smearing factor can be added when retransforming the predicted value back to its original scale to get an unbiased estimation.

In step 9, a bootstrap re-sampling technique is used to refine the MARS basis functions to build a robust model and prevent any over-fitting. Bootstrapping is a method for estimating sampling distribution of an estimator by resampling with replacement from the original sample. With the explosion in power of computation, the use of resampling methods has become increasingly viable. This has opened up a new paradigm in the area of evaluation of robustness of estimates/statistics. One method is “bootstrapping” for estimating robustness.

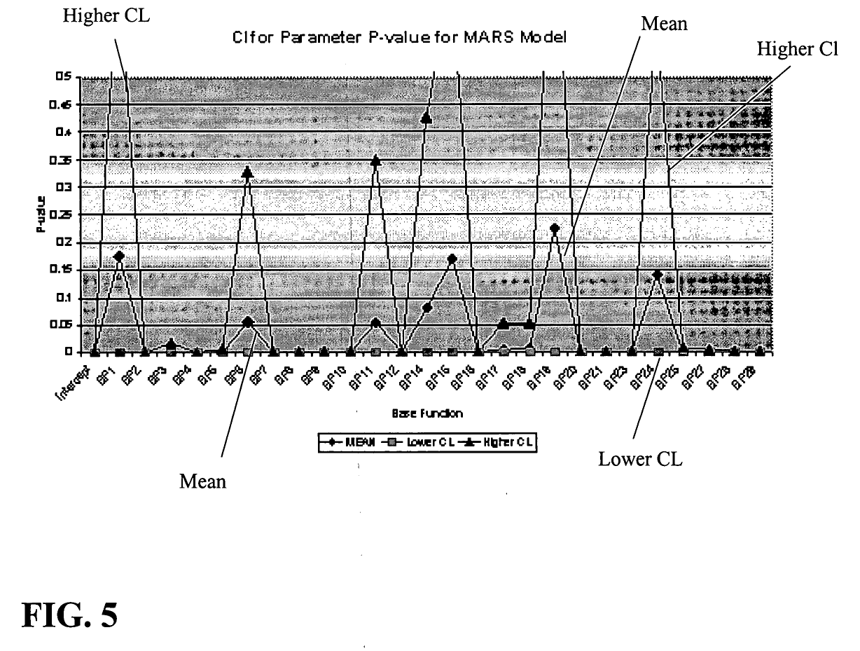

To further prevent overfitting issues in MARS, the bootstrap technique is used to further refine the chosen MARS basis functions in order to provide maximal model parsimony. More specifically, from the original development sample, bootstrap samples are drawn at random with replacement such that each observation within the sample has the same probability of being chosen. Each resample is typically of the same size as the original sample. Referring to FIG. 5, based on bootstrapping results generated from these resamples, the system computes mean/median values and confidence intervals for the significances of each basis function within the context of the particular example. Only generically robust basis functions, which are significant on a consistent basis across all resamples and with smaller span of confidence intervals, i.e., tighter confidence), are kept in the final MARS model to ensure parsimony.

In step 10, the system evaluates model prediction performance by creating a Confidence Matrix computed using the actual debt ratio and the predicted debt ratio. Although the performance of the income estimator can be evaluated from the perspective of the magnitude of errors committed on the actual income, it can be more meaningful to compare it from the ultimate debt-burden notion. This is primarily for a retail-lending business, since lending criteria is most often based on debt-burden and lenders who make use of risk-based pricing often make use of this information.

To evaluate the income estimation result created in the model development process, the predicted monthly income is translated into the predicted debt ratio by following formula:
Predicted Debt Ratio=(Monthly Actual Debt)/(Predicted Monthly Income)

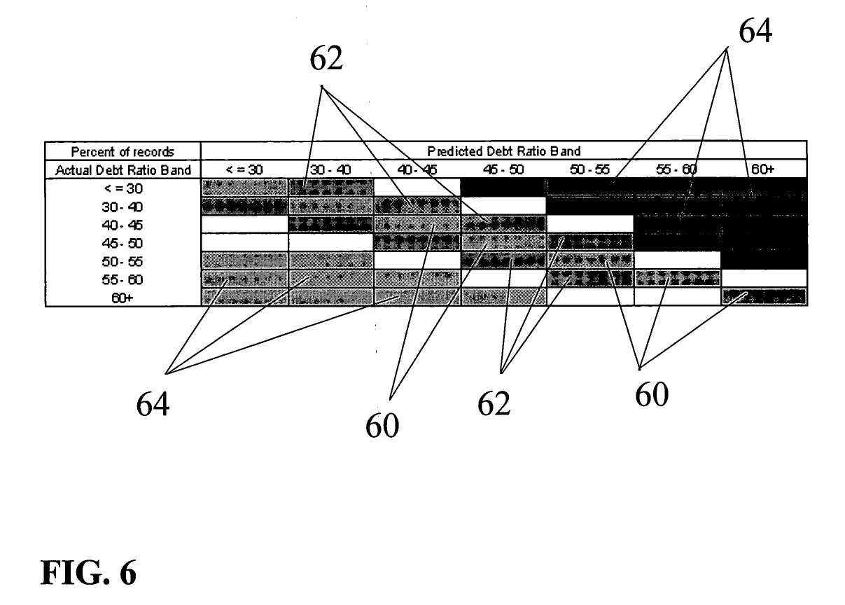

Referring to FIG. 6, a confidence matrix “M” having a dimensionality of k×k can describe the performance of an income estimator on a given data set. In confidence matrix M, k rows contain the set of actual debt ratio band defined and computed in accordance with existing underwriting guidelines and k columns contain the corresponding predicted debt ratio band.

Agreement between the actual debt ratio band and the predicted debt ratio band occurs when the case falls on the main diagonal of matrix M, represented by cells 60. A cell above or below the main diagonal contains approximate expanded matches between two debt ratio bands, represented by cells 62. Cells 64 indicate strong disagreement between the debt ratio bands.

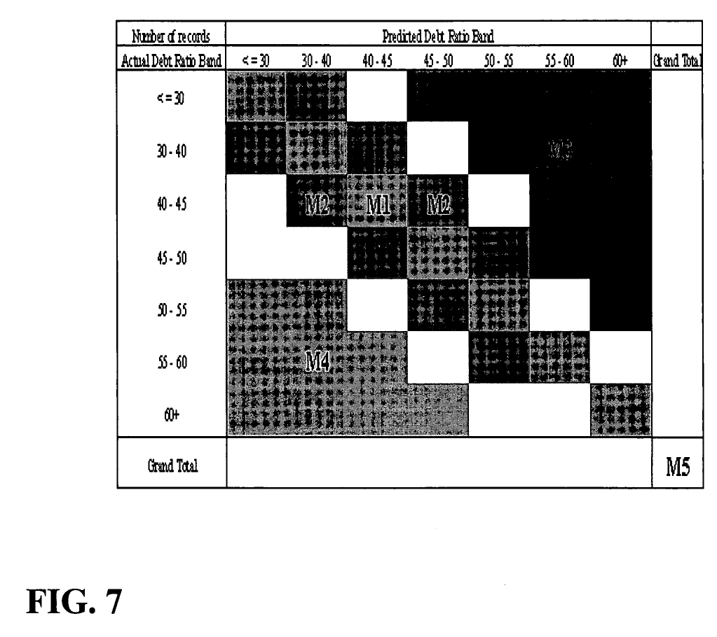

In FIG. 7, an exemplary annotated confidence matrix M is shown. M1 represents the total number of absolute agreements between actual debt ratio band and predicted debt ratio band. M2 represents the total number of expanded agreements between actual debt ratio band and predicted debt ratio band, and can have a ±5% debt-burden error. M3 represents the total number of cases where actual debt ratio band is much lower than predicted debt ratio band, and can have a chosen threshold of at least 10% over-estimation of debt-burden. M4 represents the total number of cases where actual debt ratio band is much higher than predicted debt ratio band, which are under estimation errors for cases where actual debt-burden value exceeds the absolute of 50% and error is in excess of 10%. M5 represents the total number in the data set.

The matrix M depicted in FIG. 6 illustrates the performance measures used in the evaluation of income estimator. There are six measures of performance. Absolute accuracy is the total number of absolute agreements as a percentage of total number of cases:

$$AbsoluteAccuracy = \frac{{M}_{1}}{{M}_{5}}$$

Expanded accuracy is the total number of absolute agreements together with expanded agreements as a percentage of total number of cases:

$$ExpandedAccuracy = \frac{{M}_{1} + {M}_{2}}{{M}_{5}}$$

False positive error is the total number of cases where actual debt ratio band is much higher than predicted debt ratio band as a percentage of total number of cases:

$$FalsePositiveError = \frac{{M}_{4}}{{M}_{5}}$$

False negative error is the total number of cases where actual debt ratio band is much lower than predicted debt ratio band as a percentage of total number of cases:

$$FalseNegativeError = \frac{{M}_{3}}{{M}_{5}}$$

Relative error is the summation of false negative error and false positive error:

$$RelativeError = \frac{{M}_{3} + {M}_{4}}{{M}_{5}}$$

Relative accuracy is:

$$RelativeAccuracy = 1 - \frac{{M}_{3} + {M}_{4}}{{M}_{5}}$$

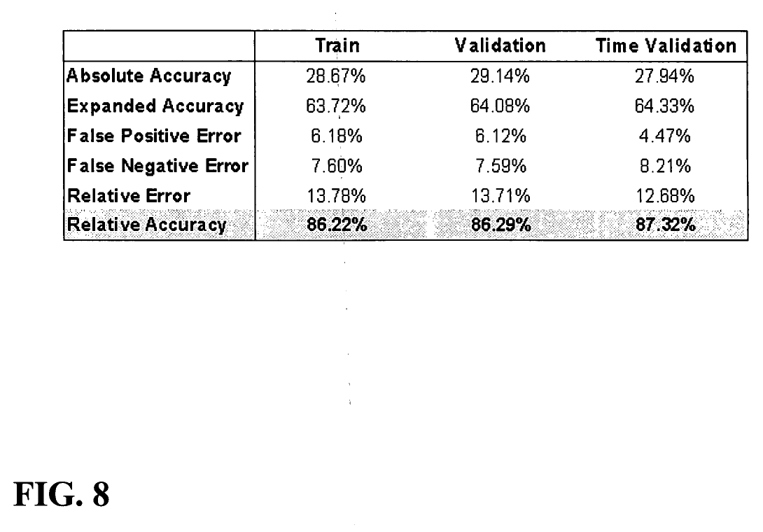

FIG. 8 depicts the performance of the MARS model on the training, validation and time validation data sets. As shown in FIG. 8, the MARS model developed is substantially robust in consistency of performance across samples and performance measures.

The embodiments described above are intended to be exemplary. Numerous alternative components and embodiments that may be substituted for the particular examples described herein and still fall within the scope of the invention.

What is claimed is:

1. An automated computer-implemented method for estimating income, the method comprising the steps of:
collecting an applicant's information;
saving the applicant's information in a record;
compiling a database comprising records of other applicants;
preprocessing the records in the database;
selecting preliminary variables;
detecting potential outliers; and
creating a model;
wherein the model is used to estimate the income of the applicant.

2. The method of claim 1, wherein the applicant's information comprises loan or credit information.

3. The method of claim 1, wherein the database comprises records of full documentation applicants.

4. The method of claim 1, wherein the database records comprise loan or credit information.

5. The method of claim 1, wherein the step of preprocessing the records in the database further comprises the step of defining a scope of the data in the database.

6. The method of claim 1, wherein the step of preprocessing the records in the database further comprises the step of handling missing values.

7. The method of claim 1, wherein the step of preprocessing the records in the database further comprises the step of recoding the data.

8. The method of claim 1, wherein the step of preprocessing the records in the database further comprises the step of performing variable transformation.

9. The method of claim 1, wherein the step of selecting preliminary variables is a process selected from the group consisting of multivariate regression, PLS regression with VIP scores, Genetic Algorithms, Neural Networks, CART, Regression Trees, and TreeNet.

10. The method of claim 1, wherein preliminary variables are selected from loan and credit information.

11. The method of claim 1, wherein the step of detecting potential outliers further comprises detecting typographical errors, uploading errors, or over-influential cases.

12. The method of claim 1, wherein the step of detecting potential outliers is a process selected from the group consisting of Euclidian distance, studentized deleted residuals, hat matrix, FFITS, Cook's distance, DFBETAS, and Random Forest.

13. The method of claim 1, wherein the step of creating a model is a process selected from the group consisting of Global Linear Multivariate Regression, regression tree, MARS, and MART/Treenet.

14. The method of claim 1, further comprising the step of bootstrapping the model.

15. The method of claim 1, further comprising the step of evaluating performance of the model.
